(19) United States
(12) Patent Application Publication
(10) Pub. No.: US 2015/0357116 A1
(43) Pub. Date: Dec. 10, 2015

(54) COIL STRUCTURE AND POWER SOURCE DEVICE

(71) Applicant: Panasonic Intellectual Property Management Co., Ltd., Osaka (JP)

(72) Inventors: TAKEHIKO YAMAKAWA, Osaka (JP); AKIRA KATO, Osaka (JP); KAZUYUKI SAKIYAMA, Osaka (JP)

(21) Appl. No.: 14/727,144

(22) Filed: Jun. 1, 2015

(30) Foreign Application Priority Data
Jun. 9, 2014 (JP) 2014-118442

(51) Int. Cl. H01F 27/28; H02M 3/335; H01F 27/30; H01F 27/24; H01F 27/32

(52) U.S. Cl. CPC H01F 27/2895; H01F 27/24; H01F 27/32; H01F 27/2823; H01F 27/306; H02M 3/33507

(57) ABSTRACT

Disclosed is a coil structure including: a first coil that is a first primary coil; a second coil that is a second primary coil; a first core around which the first coil is wound, the first core having an annular shape; a second core around which the second coil is wound, the second core having an annular shape; and a third coil that is a secondary coil, the first core including a first penetrating section that penetrates the third coil, the second core including a second penetrating section that penetrates the third coil, the first penetrating section being separated from the second penetrating section.

### BACKGROUND

1. Technical Field

The present disclosure relates to a coil structure having a coil and a power source device in which the coil structure is incorporated.

2. Description of the Related Art

Various power electronics technologies have been developed for the purpose of reducing consumption of fossil fuels such as oil and coal. Power electronics technologies are applied, for example, to electric vehicles because high efficiency of conversion from electric energy to mechanical energy can be achieved by power electronics technologies. As a result of application of power electronics technologies to vehicles, the amount of carbon emission can be markedly reduced.

A coil structure is utilized in the field of power electronics technologies. A transformer, which is one example of a coil structure, generally includes an input section connected to a circuit for input and an output section connected to a circuit for output. The output section is insulated from the input section (see Japanese Unexamined Patent Application Publication No. 2000-353627).

### SUMMARY

One non-limiting and exemplary embodiment provides a coil structure and a power source device that can achieve high power supply efficiency.

In one general aspect, the techniques disclosed here feature a coil structure that includes: a first coil that is a first primary coil; a second coil that is a second primary coil; a first core around which the first coil is wound, the first core having an annular shape; a second core around which the second coil is wound, the second core having an annular shape; and a third coil that is a secondary coil, the first core including a first penetrating section that penetrates the third coil, the second core including a second penetrating section that penetrates the third coil, the first penetrating section being separated from the second penetrating section.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a concept diagram of a coil structure of the First Embodiment;

FIG. 2 is a graph showing a relationship between the coupling coefficient and a gap (Second Embodiment);

FIG. 3 is a concept diagram of a coil structure of the Third Embodiment;

FIG. 4 is a front view schematically illustrating a coil structure of the Fourth Embodiment;

FIG. 5 is a front view schematically illustrating a coil structure of the Fifth Embodiment;

FIG. 6A is a front view schematically illustrating a coil structure of the Sixth Embodiment;

FIG. 6B is a perspective view schematically illustrating the coil structure illustrated in FIG. 6A;

FIG. 7A is a front view schematically illustrating a coil structure of the Seventh Embodiment;

FIG. 7B is a side view schematically illustrating the coil structure illustrated in FIG. 7A;

FIG. 8 is a perspective view schematically illustrating a coil structure of the Eighth Embodiment;

FIG. 9 is a block diagram schematically illustrating a power source device of the Ninth Embodiment;

FIG. 10 is a timing diagram schematically showing the concept of control of the power source device illustrated in FIG. 9 (Tenth Embodiment);

FIG. 11A is a perspective cross-sectional view schematically illustrating the coil structure illustrated in FIG. 6B;

FIG. 11B is a perspective cross-sectional view schematically illustrating the coil structure illustrated in FIG. 6B;

FIG. 12 is a circuit diagram schematically illustrating a processing section of the power source device illustrated in FIG. 9 (Eleventh Embodiment);

FIG. 13 is a timing diagram schematically showing the concept of control of the power source device illustrated in FIG. 9 (Twelfth Embodiment);

FIG. 14 is a circuit diagram schematically illustrating a processing section of the power source device illustrated in FIG. 9 (Thirteenth Embodiment);

FIG. 15 is a timing diagram showing the concept of control of the power source device illustrated in FIG. 9 (Fourteenth Embodiment);

FIG. 16 is a circuit diagram schematically illustrating a conventional converter circuit; and

FIG. 17 is a cross-sectional view schematically illustrating a transformer of the converter circuit illustrated in FIG. 16.

### DETAILED DESCRIPTION

A coil structure according to one aspect of the present disclosure includes a first coil that is a first primary coil; a second coil that is a second primary coil; a first core around which the first coil is wound, the first core having an annular shape; a second core around which the second coil is wound, the second core having an annular shape; and a third coil that is a secondary coil, the first core including a first penetrating section that penetrates the third coil, the second core including a second penetrating section that penetrates the third coil, the first penetrating section being separated from the second penetrating section.

According to the arrangement, since the first penetrating section is separated from the second penetrating section, the coupling coefficient between the primary coils is very small. Therefore, substantially synchronized power supply to the first coil and the second coil is possible. As a result, the coil structure can achieve high power supply efficiency.

In the arrangement, the coil structure may further include an insulating member located between the first penetrating section and the second penetrating section.

According to the arrangement, since the insulating member is located between the first penetrating section and the second penetrating section, the coupling coefficient between the primary coils is very small. Therefore, substantially synchronized power supply to the first coil and the second coil is possible. As a result, the coil structure can achieve high power supply efficiency.

In the arrangement, the third coil may be located between the first coil and the second coil.

According to the arrangement, since the third coil is located between the first coil and the second coil, a designer can design the coil structure so that there is a large distance between the first coil and the second coil. Accordingly, the coupling coefficient between the primary coils is very small. Therefore, substantially synchronized power supply to the first coil and the second coil is possible. As a result, the coil structure can achieve high power supply efficiency.

In the arrangement, the first core may include a third penetrating section that penetrates the first coil. The first penetrating section may include a first connection end connected to the third penetrating section and a first opposite end that is opposite to the first connection end. The second core may include a fourth penetrating section that penetrates the second coil. The second penetrating section may include a second connection end connected to the fourth penetrating section and a second opposite end that is opposite to the second connection end. The distance between the first connection end and the second connection end may be longer than a distance between the first opposite end and the second connection end.

According to the arrangement, since the distance between the first connection end and the second connection end is longer than the distance between the first opposite end and the second connection end, a designer can design the coil structure so that there is a large distance between the first coil and the second coil. Accordingly, the coupling coefficient between the primary coils is very small. Therefore, substantially synchronized power supply to the first coil and the second coil is possible. As a result, the coil structure can achieve high power supply efficiency.

In the arrangement, the first core may include a third penetrating section that penetrates the first coil. The first penetrating section may include a first connection end connected to the third penetrating section and a first opposite end that is opposite to the first connection end. The second core may include a fourth penetrating section that penetrates the second coil. The second penetrating section may include a second connection end connected to the fourth penetrating section and a second opposite end that is opposite to the second connection end. A distance between the first connection end and the second connection end may be shorter than a distance between the first connection end and the second opposite end.

According to the arrangement, since the distance between the first connection end and the second connection end is shorter than the distance between the first connection end and the second opposite end, a designer can design the coil structure so that the first coil is located close to the second coil. Therefore, the designer can make the dimensions of the coil structure small.

In the arrangement, the first penetrating section may be separated by 0.2 mm or more from the second penetrating section.

According to the arrangement, since the first penetrating section is separated by 0.2 mm or more from the second penetrating section, the coupling coefficient between the primary coils is very small. Therefore, substantially synchronized power supply to the first coil and the second coil is possible. As a result, the coil structure can achieve high power supply efficiency.

In the arrangement, the coil structure may further include: a fourth coil that is a third primary coil; and a third core around which the fourth coil is wound, the first core having an annular shape. The third core may include a fifth penetrating section that penetrates the third coil. The fifth penetrating section may be separated from the first penetrating section and the second penetrating section.

According to the arrangement, since the coil structure further includes a fourth coil that is a third primary coil and an annular third core around which the fourth coil is wound, the coil structure can receive a lot of electric power and output a lot of electric power.

A power source device according to another aspect of the present disclosure includes the above coil structure. The power source device includes a first input section including the first coil; a second input section including the second coil; an output section including the third coil; and a control section operative to control the first input section and the second input section.

According to the arrangement, since the power source device includes the above coil structure, it is possible to achieve high power supply efficiency.

In the arrangement, the control section sets a first period in which the control section causes the first input section to generate a first magnetic flux flowing along the first penetrating section in a first direction and a second period in which the control section causes the second input section to generate a second magnetic flux flowing along the second penetrating section in a second direction opposite to the first direction. The second period may be separated from the first period.

According to the arrangement, since the second period is separated from the first period, the likelihood of concurrent occurrence of the second magnetic flux flowing in the second direction and the first magnetic flux flowing in the first direction is very low. As a result, the power source device can achieve high power supply efficiency.

In the arrangement, during the second period, the control section may cause the first input section to generate a third magnetic flux flowing along the first penetrating section in the second direction.

According to the arrangement, since the second magnetic flux and the third magnetic flux flow in the second direction during the second period, the power source device can achieve high power supply efficiency.

In the arrangement, during the first period, the control section may cause the second input section to generate a fourth magnetic flux flowing along the second penetrating section in the first direction.

According to the arrangement, since the first magnetic flux and the fourth magnetic flux flow in the first direction during the first period, the power source device can achieve high power supply efficiency.

In the arrangement, the first input section may include a first power source that outputs first direct-current power, a first switch circuit section connected in parallel with the first power source, and a second switch circuit section connected in parallel with the first power source and the first switch circuit section. The first switch circuit section may include a first switch element and a second switch element connected in series with the first switch element. The second switch circuit section may include a third switch element and a fourth switch element connected in series with the third switch element. The first coil may be connected to a first connection point between the first switch element and the second switch element and to a second connection point between the third switch element and the fourth switch element. The control section may control the first switch element, the second switch element, the third switch element, and the fourth switch element.

According to the arrangement, since the control section controls the first switch element, the second switch element, the third switch element, and the fourth switch element, it is possible to properly switch a direction of an electric current flowing into the first coil.

In the arrangement, the second input section may include a second power source that supplies second direct-current power, a third switch circuit section connected in parallel with the second power source, and a fourth switch circuit section connected in parallel with the second power source and the third switch circuit section. The third switch circuit section may include a fifth switch element and a sixth switch element connected in series with the fifth switch element. The fourth switch circuit section may include a seventh switch element and an eighth switch element connected in series with the seventh switch element. The second coil may be connected to a third connection point between the fifth switch element and the sixth switch element and to a fourth connection point between the seventh switch element and the eighth switch element. The control section may control the fifth switch element, the sixth switch element, the seventh switch element, and the eighth switch element.

According to the arrangement, since the control section controls the fifth switch element, the sixth switch element, the seventh switch element, and the eighth switch element, it is possible to properly switch the direction in which an electric current flows into the second coil.

Various embodiments concerning a coil structure and an electric power device are described below with reference to the attached drawings. The coil structure and the electric power device can be clearly understood from the following description. Terms, such as “upper”, “lower”, “left”, and “right”, indicative of directions are merely used for clarification of the description. Therefore, these terms should not be interpreted in a limited manner.

### Problems of Conventional Art

The inventors of the present invention conducted a study on a power converter circuit in which a conventional coil structure is incorporated and found that the conventional art has a problem of low power supply efficiency. The problem of the conventional power converter circuit is described below.

FIG. 16 is a circuit diagram schematically illustrating a conventional converter circuit 900 (push-pull type). The converter circuit 900 is described with reference to FIG. 16.

The converter circuit 900 includes a direct-current power source 910, a transformer 920, a first switch 931, a second switch 932, a bridge circuit 940, a choke coil 950, and a smoothing capacitor 960.

The transformer 920 includes a first coil 921, a second coil 922, a third coil 923, and a center tap 924. The first coil 921 and the second coil 922 are used as primary coils. The third coil 923 is used as a secondary coil.

The first coil 921 is connected to the direct-current power source 910 through the center tap 924. The first coil 921 is also connected to the first switch 931. Accordingly, an electric current from the direct-current power source 910 flows into the first coil 921 in accordance with an ON operation of the first switch 931.

The second coil 922 is connected to the direct-current power source 910 through the center tap 924. The second coil 922 is also connected to the second switch 932. Accordingly, an electric current from the direct-current power source 910 flows into the second coil 922 in accordance with an ON operation of the second switch 932.

The bridge circuit 940 includes four diodes 941, 942, 943, and 944. The bridge circuit 940 is connected to the third coil 923. Supply of power to the first coil 921 and the second coil 922 generates an induced electric current in the third coil 923. The induced electric current flows into the bridge circuit 940. The bridge circuit 940 rectifies the induced electric current.

The choke coil 950 is connected to the bridge circuit 940 and the smoothing capacitor 960. The electric current rectified by the bridge circuit 940 is outputted through the choke coil 950. The smoothing capacitor 960 reduces a fluctuation of the output voltage.

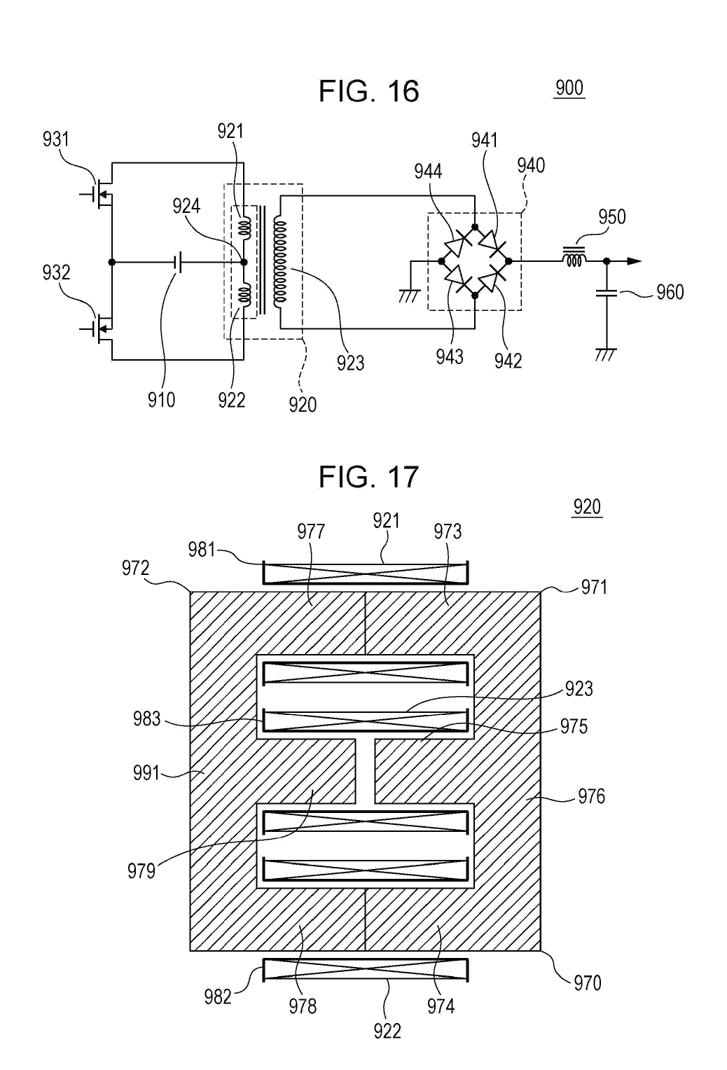

FIG. 17 is a cross-sectional view schematically illustrating the transformer 920. The converter circuit 900 is further described with reference to FIGS. 16 and 17.

The transformer 920 includes a magnetic core 970, a first bobbin 981, a second bobbin 982, and a third bobbin 983. The first coil 921 is made of a wire rod that is wound around the first bobbin 981. The second coil 922 is made of a wire rod that is wound around the second bobbin 982. The third coil 923 is made of a wire rod that is wound around the third bobbin 983.

The magnetic core 970 includes a right core 971 and a left core 972. Both of the right core 971 and the left core 972 are substantially E-shaped.

The right core 971 includes an upper core leg 973, a lower core leg 974, an intermediate core leg 975, and a connecting part 976. The upper core leg 973 extends from an upper end of the connecting part 976 toward the left core 972. The lower core leg 974 extends from a lower end of the connecting part 976 toward the left core 972. The intermediate core leg 975 between the upper core leg 973 and the lower core leg 974 extends from the connecting part 976 toward the left core 972.

The left core 972 includes an upper core leg 977, a lower core leg 978, an intermediate core leg 979, and a connecting part 991. The upper core leg 977 extends from an upper end of the connecting part 991 toward the right core 971. The lower core leg 978 extends from a lower end of the connecting part 991 toward the right core 971. The intermediate core leg 979 between the upper core leg 977 and the lower core leg 978 extends from the connecting part 991 toward the right core 971.

An end surface of the upper core leg 973 of the right core 971 is in contact with an end surface of the upper core leg 977 of the left core 972. The upper core legs 973 and 977 are inserted into the first bobbin 981.

An end surface of the lower core leg 974 of the right core 971 is in contact with an end surface of the lower core leg 978 of the left core 972. The lower core legs 974 and 978 are inserted into the second bobbin 982.

An end surface of the intermediate core leg 975 of the right core 971 is separated from an end surface of the intermediate core leg 979 of the left core 972. Both of the intermediate core legs 975 and 979 are inserted into the third bobbin 983.

The first switch 931 and the second switch 932 are controlled by a control circuit (not illustrated). The control circuit causes the second switch 932 to be in an OFF mode while the control circuit causes the first switch 931 to be in an ON mode. The control circuit causes the second switch 932 to be in an ON mode while the control circuit causes the first switch 931 to be in an OFF mode. That is, the control circuit controls the first switch 931 and the second switch 932 so that the ON mode of the first switch 931 is not synchronized with the ON mode of the second switch 932.

As a result of the aforementioned control of the first switch 931 and the second switch 932, a pulsating voltage occurs in the pair of primary coils (i.e., the first coil 921 and the second coil 922).

An upper magnetic flux that flows along a magnetic path defined by the upper core legs 973 and 977, the connecting parts 976 and 991, and the intermediate core legs 975 and 979 occurs while the control circuit causes the first switch 931 to be in an ON mode. A lower magnetic flux that flows along a magnetic path defined by the lower core legs 974 and 978, the connecting parts 976 and 991, and the intermediate core legs 975 and 979 occurs while the control circuit causes the second switch 932 to be in an ON mode.

As a result of the aforementioned control of the first switch 931 and the second switch 932, the upper magnetic flux and the lower magnetic flux alternately occur. Consequently, a pulsating voltage also occurs in the third coil 923.

If the ON mode of the first switch 931 is synchronized with the ON mode of the second switch 932, the upper magnetic flux cancels out the lower magnetic flux. As a result, impedance between the pair of first switch 931 and second switch 932 and the pair of first coil 921 and second coil 922 becomes very low. This leads to an excessively large through-current that flows into the first switch 931 and the second switch 932. The excessively large through-current may undesirably break the first switch 931 and the second switch 932.

As described above, in the converter circuit 900, the ON mode of the first switch 931 cannot be synchronized with the ON mode of the second switch 932. Therefore, it is necessary to separately prepare a period for power supply to the first coil 921 and a period for power supply to the second coil 922. As a result, the power supply efficiency is very low.

The coupling coefficient between the first coil 921 and the second coil 922 is not low enough to prevent some of the upper magnetic flux (or the lower magnetic flux) from flowing into the lower core legs 974 and 978 (or the upper core legs 973 and 977). Accordingly, a loss occurs in the power supply from the primary coils (i.e., the pair of first coil 921 and second coil 922) to the secondary coil (i.e., the third coil 923). Also in this respect, the power supply efficiency is very low.

### First Embodiment

The inventors of the present invention developed a coil structure that can properly solve the above problems. In the First Embodiment, the design principle of the coil structure is described.

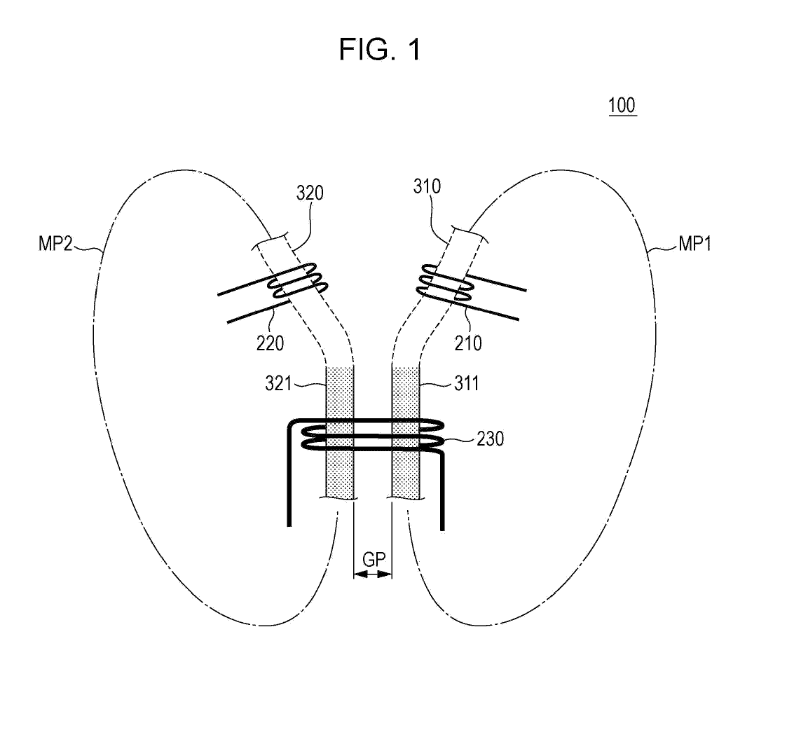

FIG. 1 is a concept diagram of a coil structure 100 of the First Embodiment. The coil structure 100 is described below with reference to FIG. 1.

The coil structure 100 includes a first coil 210, a second coil 220, a third coil 230, an annular first core 310, and an annular second core 320. The first coil 210 and the second coil 220 are used as primary coils. The third coil 230 is used as a secondary coil.

The first core 310 is made of a magnetic material. The first coil 210 is wound around part of the first core 310. The first core 310 defines an annular magnetic path MP1 along which a magnetic flux occurring due to power supply to the first coil 210 flows. The designer of the coil structure 100 may give the first core 310 any of various shapes. For example, the first core 310 may have a triangular contour, a rectangular contour, and other polygonal contours. Alternatively, the first core 310 may have a contour including a curve (e.g., a circular shape or an oval shape). The principle of the present embodiment is not limited to a specific shape of the first core 310.

A manufacturer of the coil structure 100 may form the first core 310 from a single magnetic piece. Alternatively, the manufacturer may form the first core 310 from a plurality of magnetic pieces. For example, the manufacturer may form the first core 310 from two U-shaped magnetic pieces. Alternatively, the manufacturer may form the first core 310 by using a U-shaped magnetic piece and an I-shaped magnetic piece. The principle of the present embodiment is not limited to a specific structure of the first core 310.

The second core 320 is made of a magnetic material. The second coil 220 is wound around part of the second core 320. The second core 320 defines an annular magnetic path MP2 along which a magnetic flux occurring due to power supply to the second coil 220 flows. The designer of the coil structure 100 may give the second core 320 any of various shapes. For example, the second core 320 may have a triangular contour, a rectangular contour, and other polygonal contours. Alternatively, the second core 320 may have a contour including a curve (e.g., an annular shape or an oval shape). The principle of the present embodiment is not limited to a specific shape of the second core 320.

The manufacturer of the coil structure 100 may form the second core 320 from a single magnetic piece. Alternatively, the manufacturer may form the second core 320 by using a plurality of magnetic pieces. For example, the manufacturer may form the second core 320 by using two U-shaped magnetic pieces. Alternatively, the manufacturer may form the second core 320 by using a U-shaped magnetic piece and an I-shaped magnetic piece. The principle of the present embodiment is not limited to a specific structure of the second core 320.

The first core 310 includes a penetrating section 311 that penetrates the third coil 230. The second core 320 includes a penetrating section 321 that penetrates the third coil 230. In the present embodiment, a first penetrating section is exemplified by the penetrating section 311. A second penetrating section is exemplified by the penetrating section 321.

The penetrating section 311 is separated from the penetrating section 321. Accordingly, the coupling coefficient between the first coil 210 and the second coil 220 is very small. Power supply to the first coil 210 negligibly generates a magnetic flux in the second core 320. Power supply to the second coil 220 negligibly generates a magnetic flux in the first core 310.

The above characteristics of the coil structure 100 allow synchronized power supply to the first coil 210 and the second coil 220. Therefore, the coil structure 100 can contribute to realization of high power supply efficiency.

### Second Embodiment

The inventors of the present invention conducted a study on a relationship between the coupling coefficient between two primary coils and a gap between two annular cores. In the Second Embodiment, a proper size of the gap between the two annular cores is described.

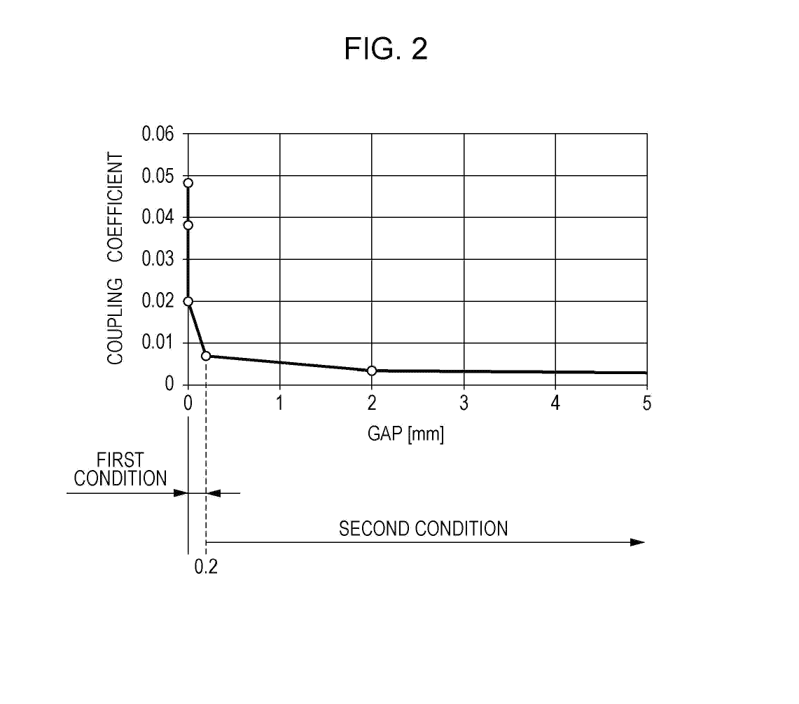

FIG. 2 is a graph showing a relationship between the coupling coefficient and a gap GP (see FIG. 1). The relationship between the coupling coefficient and the gap GP is described with reference to FIGS. 1 and 2.

The graph of FIG. 2 shows a result of electromagnetic field analysis using a finite element method. The horizontal axis of the graph of FIG. 2 represents the gap GP between the penetrating sections 311 and 321. The vertical axis of the graph of FIG. 2 represents the coupling coefficient between the first coil 210 and the second coil 220.

Under a first condition that the gap GP is not less than 0 mm and less than 0.2 mm, the coupling coefficient rapidly decreases as the gap GP increases. This means that the magnetic flux that occurs in the first core 310 due to power supply to the first coil 210 also flows into the second core 320 and that the magnetic flux that occurs in the second core 320 due to power supply to the second coil 220 also flows into the first core 310.

Under a second condition that the gap GP is not less than 0.2 mm, the coupling coefficient is kept at a low level of 0.01 or lower. This means that most of the magnetic flux that occurs in the first core 310 due to power supply to the first coil 210 is trapped inside the first core 310 and that most of the magnetic flux that occurs in the second core 320 due to power supply to the second coil 220 is trapped inside the second core 320. Therefore, in a case where the gap GP is set to not less than 0.2 mm, power supplied to the first coil 210 and power supplied to the second coil 220 are efficiently transmitted to the third coil 230.

The designer of the coil structure 100 may set the gap GP between the penetrating sections 311 and 321 to not less than 0.2 mm on the basis of the simulation result shown in FIG. 2. As a result, the coil structure 100 can contribute to accomplishment of high power supply efficiency.

### Third Embodiment

The designer may dispose an insulating member between two annular cores. The insulating member makes it hard for a magnetic flux to flow from one annular core to the other. This increases the power supply efficiency of a coil structure. In the Third Embodiment, the design principle of a coil structure including an insulating member is described.

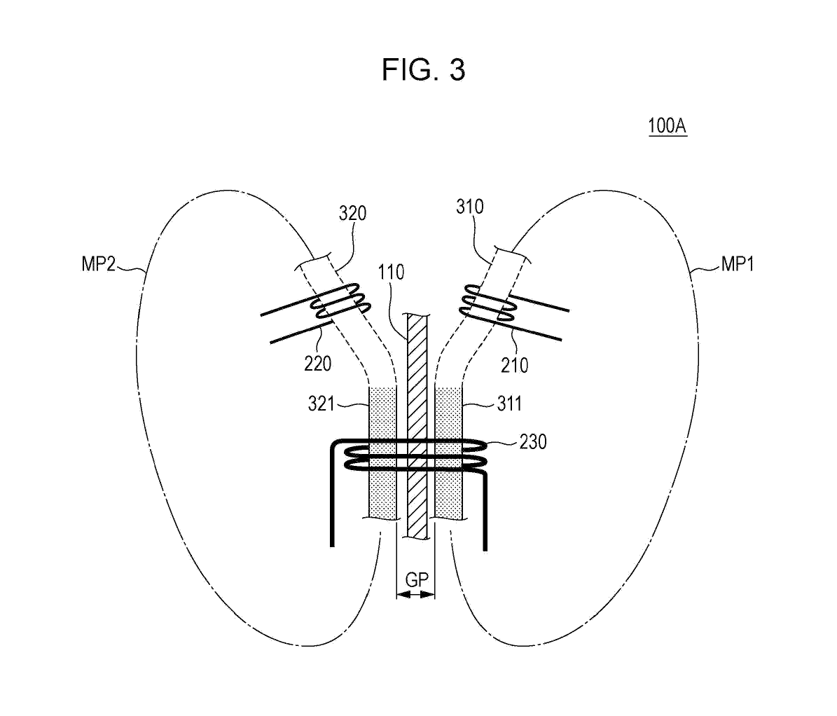

FIG. 3 is a concept diagram of a coil structure 100A of the Third Embodiment. The coil structure 100A is described with reference to FIG. 3. Reference signs common to the First Embodiment and the Third Embodiment mean that elements given these reference signs have identical functions to those in the First Embodiment. Therefore, the description in the First Embodiment is applied to these elements.

As in the First Embodiment, the coil structure 100A includes a first coil 210, a second coil 220, a third coil 230, an annular first core 310, and an annular second core 320. The description of the First Embodiment is applied to these elements.

The coil structure 100A further includes an insulating member 110 located between penetrating sections 311 and 321. The insulating member 110 has an insulating property that reduces a magnetic flux flowing from the first core 310 to the second core 320 and a magnetic flux flowing from the second core 320 to the first core 310. Therefore, the magnetic flux that occurs due to power supply to the first coil 210 is properly trapped inside the first core 310. The magnetic flux that occurs due to power supply to the second coil 220 is properly trapped inside the second core 320.

The insulating member 110 may be an insulating tape used for a general transformer. The principle of the present embodiment is not limited to a specific kind of the insulating member 110.

### Fourth Embodiment

The designer can design various coil structures on the basis of the design principle described in association with the First Embodiment. The designer may weaken coupling between a first coil and a second coil by separating the first coil away from the second coil. In the Fourth Embodiment, the design principle of an exemplary coil structure is described.

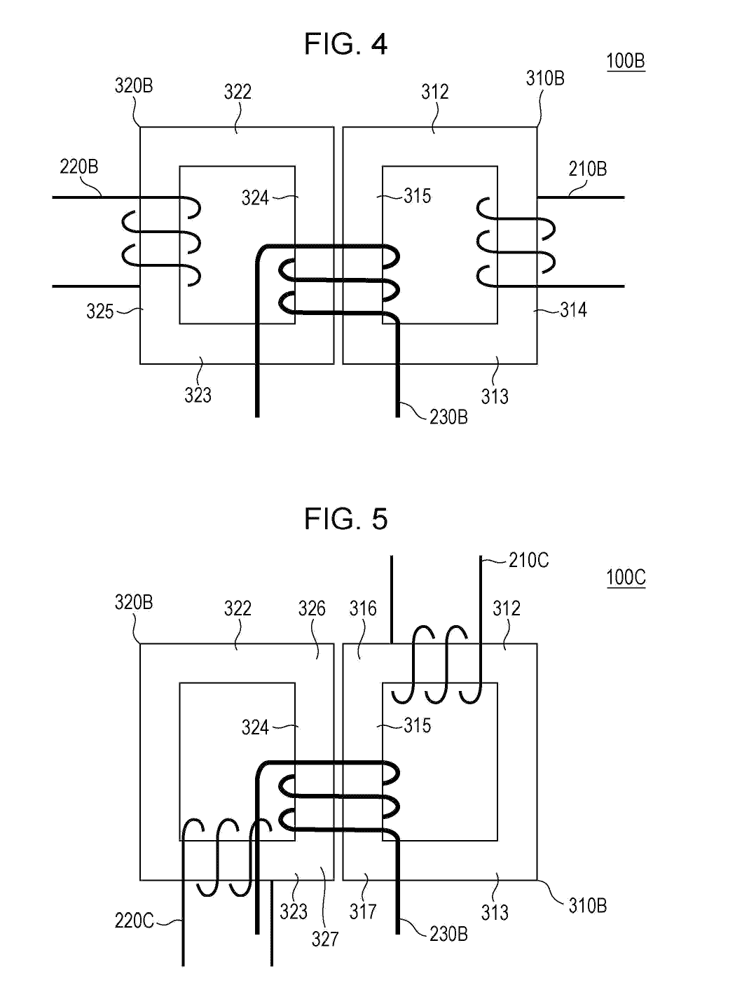

FIG. 4 is a front view schematically illustrating a coil structure 100B of the Fourth Embodiment. The coil structure 100B is described below with reference to FIGS. 1 and 4.

The coil structure 100B includes a first coil 210B, a second coil 220B, a third coil 230B, a first core 310B, and a second core 320B. The first coil 210B corresponds to the first coil 210 described with reference to FIG. 1. The second coil 220B corresponds to the second coil 220 described with reference to FIG. 1. The third coil 230B corresponds to the third coil 230 described with reference to FIG. 1. The first core 310B corresponds to the first core 310 described with reference to FIG. 1. The second core 320B corresponds to the second core 320 described with reference to FIG. 1.

The first coil 210B, the second coil 220B, and the third coil 230B may be conductive layers printed on a circuit board (not illustrated). Alternatively, the first coil 210B, the second coil 220B, and the third coil 230B may be made of a wire rod that is wound around a bobbin (not illustrated). The principle of the present embodiment is not limited to a specific structure of the first coil 210B, the second coil 220B, and the third coil 230B.

The first core 310B includes an upper magnetic rod 312, a lower magnetic rod 313, a right magnetic rod 314, and a left magnetic rod 315. The upper magnetic rod 312 extends in a substantially horizontal direction above the lower magnetic rod 313. The lower magnetic rod 313 extends in a substantially horizontal direction below the upper magnetic rod 312. The right magnetic rod 314 extends in a substantially vertical direction between a right end of the upper magnetic rod 312 and a right end of the lower magnetic rod 313. The left magnetic rod 315 extends in a substantially vertical direction between a left end of the upper magnetic rod 312 and a left end of the lower magnetic rod 313. Therefore, the first core 310B defines an annular magnetic path that is substantially rectangular.

The second core 320B includes an upper magnetic rod 322, a lower magnetic rod 323, a right magnetic rod 324, and a left magnetic rod 325. The upper magnetic rod 322 extends in a substantially horizontal direction above the lower magnetic rod 323. The lower magnetic rod 323 extends in a substantially horizontal direction below the upper magnetic rod 322. The right magnetic rod 324 extends in a substantially vertical direction between a right end of the upper magnetic rod 322 and a right end of the lower magnetic rod 323. The left magnetic rod 325 extends in a substantially vertical direction between a left end of the upper magnetic rod 322 and a left end of the lower magnetic rod 323. Therefore, the second core 320B defines an annular magnetic path that is substantially rectangular.

The first coil 210B is wound around the right magnetic rod 314 of the first core 310B. The second coil 220B is wound around the left magnetic rod 325 of the second core 320B. The third coil 230B is wound around the left magnetic rod 315 of the first core 310B and the right magnetic rod 324 of the second core 320B. A positional relationship between the first core 310B and the second core 320B is set so that the left magnetic rod 315 of the first core 310B and the right magnetic rod 324 of the second core 320B are located between the right magnetic rod 314 of the first core 310B and the left magnetic rod 325 of the second core 320B. Accordingly, the third coil 230B is formed between the first coil 210B and the second coil 220B. The left magnetic rod 315 of the first core 310B corresponds to the penetrating section 311 described with reference to FIG. 1. The right magnetic rod 324 of the second core 320B corresponds to the penetrating section 321 described with reference to FIG. 1.

The coil structure 100B allows the first coil 210B to be located away from the second coil 220B. Therefore, magnetic coupling between the first coil 210B and the second coil 220B is very weak.

### Fifth Embodiment

The designer can design various coil structures on the basis of the design principle described in association with the First Embodiment. The designer may weaken coupling between a first coil and a second coil by separating the first coil away from the second coil. In the Fifth Embodiment, the design principle of an exemplary coil structure is described.

FIG. 5 is a front view schematically illustrating a coil structure 100C of the Fifth Embodiment. The coil structure 100C is described below with reference to FIGS. 1 and 5. Reference signs common to the Fourth Embodiment and the Fifth Embodiment mean that elements given these reference signs have identical functions to those in the Fourth Embodiment. Therefore, the description in the Fourth Embodiment is applied to these elements.

As in the Fourth Embodiment, the coil structure 100C includes a third coil 230B, a first core 310B, and a second core 320B. The description of the Fourth Embodiment is applied to these elements.

The coil structure 100C further includes a first coil 210C and a second coil 220C. The first coil 210C is penetrated by an upper magnetic rod 312 of the first core 310B. The second coil 220C is penetrated by a lower magnetic rod 323 of the second core 320B. The first coil 210C corresponds to the first coil 210 described with reference to FIG. 1. The second coil 220C corresponds to the second coil 220 described with reference to FIG. 1. In the present embodiment, a third penetrating section is exemplified by the upper magnetic rod 312 of the first core 310B. A fourth penetrating section is exemplified by the lower magnetic rod 323 of the second core 320B.

The upper magnetic rod 312 of the first core 310B is connected to a left magnetic rod 315 of the first core 310B so as to form an upper corner 316. The lower magnetic rod 313 of the first core 310B is connected to a left magnetic rod 315 of the first core 310B so as to form a lower corner 317 that is opposite to the upper corner 316. In the present embodiment, a first connection end is exemplified by the upper corner 316. A first opposite end is exemplified by the lower corner 317.

An upper magnetic rod 322 of the second core 320B is connected to a right magnetic rod 324 of the second core 320B so as to form an upper corner 326. A lower magnetic rod 323 of the second core 320B is connected to the right magnetic rod 324 of the second core 320B so as to form a lower corner 327 that is opposite to the upper corner 326. In the present embodiment, a second connection end is exemplified by the lower corner 327. A second opposite end is exemplified by the upper corner 326.

A distance between the upper corner 316 of the first core 310B and the lower corner 327 of the second core 320B is longer than a distance between the upper corners 316 and 326. Therefore, the coil structure 100C allows the first coil 210C to be located away from the second coil 220C. Consequently, magnetic coupling between the first coil 210C and the second coil 220C is very weak.

### Sixth Embodiment

The designer can design various coil structures on the basis of the design principle described in association with the First Embodiment. The designer can design a small coil structure by disposing a first coil close to a second coil. In Sixth Embodiment, the design principle of an exemplary coil structure is described.

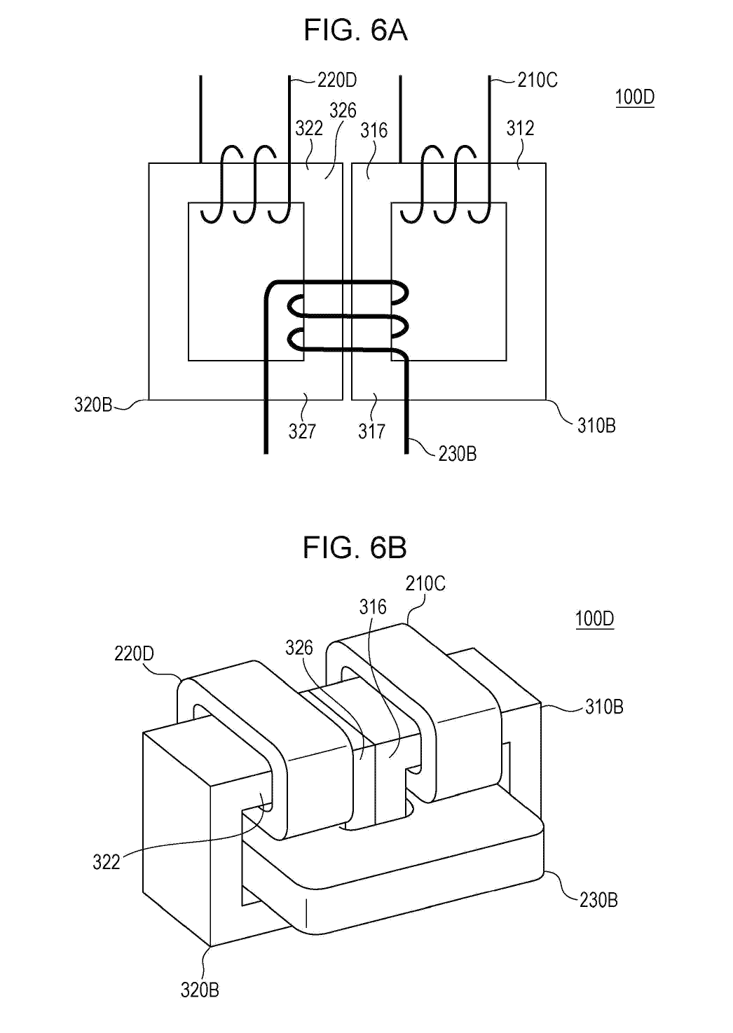

FIG. 6A is a front view schematically illustrating a coil structure 100D of Sixth Embodiment. FIG. 6B is a perspective view schematically illustrating the coil structure 100D. The coil structure 100D is described with reference to FIGS. 1, 6A, and 6B. Reference signs common to the Fifth Embodiment and the Sixth Embodiment mean that elements given these reference signs have identical functions to those in the Fifth Embodiment. Therefore, the description in the Fifth Embodiment is applied to these elements.

As in the Fifth Embodiment, the coil structure 100D includes a first coil 210C, a third coil 230B, a first core 310B, and a second core 320B. The description of the Fifth Embodiment is applied to these elements.

The coil structure 100D further includes a second coil 220D. The second coil 220D is penetrated by an upper magnetic rod 322 of the second core 320B. The second coil 220D corresponds to the second coil 220 described with reference to FIG. 1. In the present embodiment, a fourth penetrating section is exemplified by the upper magnetic rod 322 of the second core 320B.

A distance between an upper corner 316 of the first core 310B and an upper corner 326 of the second core 320B is shorter than a distance between the upper corner 316 of the first core 310B and a lower corner 327 of the second core 320B. Accordingly, the coil structure 100D allows the first coil 210C to be located close to the second coil 220D. Therefore, the designer can give a small dimension to the coil structure 100D. In the present embodiment, a second connection end is exemplified by the upper corner 326 of the second core 320B. A second opposite end is exemplified by the lower corner 327 of the second core 320B.

The first coil 210C and the second coil 220D are attached to the upper magnetic rods 312 and 322, respectively. Therefore, the designer can simplify a wiring structure for supplying power to the first coil 210C and the second coil 220D.

### Seventh Embodiment

The designer can design various coil structures on the basis of the design principle described in association with the First Embodiment. The designer can design a small coil structure by disposing a first coil close to a second coil. In the Seventh Embodiment, the design principle of an exemplary coil structure is described.

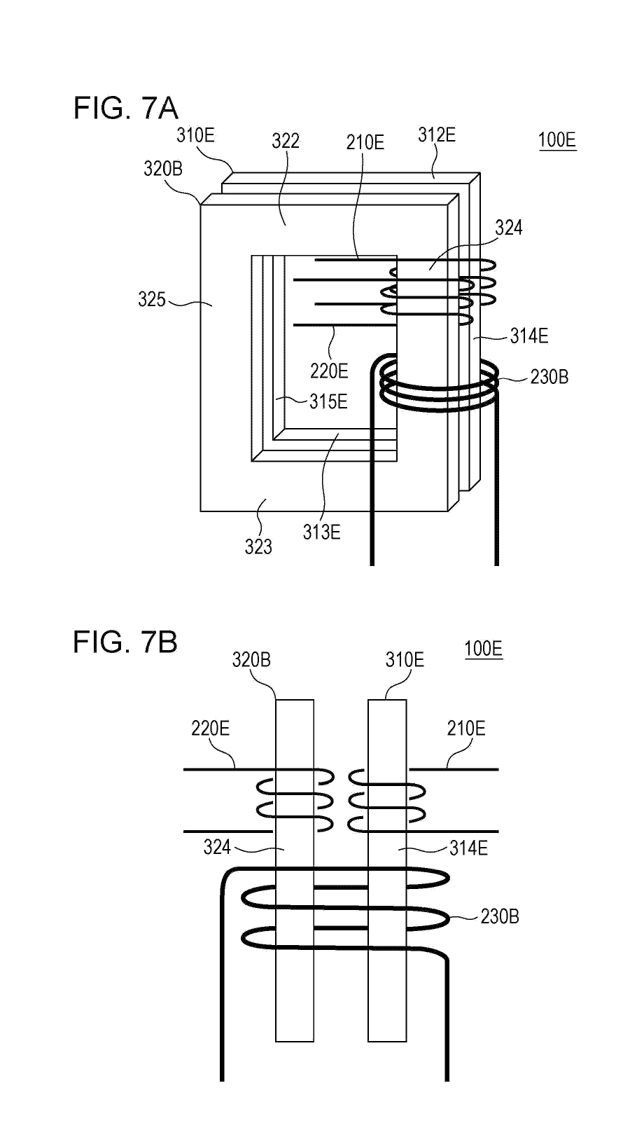

FIG. 7A is a front view schematically illustrating a coil structure 100E of the Seventh Embodiment. FIG. 7B is a side view schematically illustrating the coil structure 100E. The coil structure 100E is described with reference to FIGS. 1, 7A, and 7B. Reference signs common to the Sixth Embodiment and the Seventh Embodiment mean that elements given these reference signs have identical functions to those in the Sixth Embodiment. Therefore, the description in the Sixth Embodiment is applied to these elements.

As in the Sixth Embodiment, the coil structure 100E includes a third coil 230B and a second core 320B. The description of the Sixth Embodiment is applied to these elements.

The coil structure 100E further includes a first coil 210E, a second coil 220E, and a first core 310E. The first core 310E includes an upper magnetic rod 312E, a lower magnetic rod 313E, a right magnetic rod 314E, and a left magnetic rod 315E. The upper magnetic rod 312E of the first core 310E extends in a substantially horizontal direction beside an upper magnetic rod 322 of the second core 320B. The lower magnetic rod 313E of the first core 310E extends in a substantially horizontal direction beside a lower magnetic rod 323 of the second core 320B. The right magnetic rod 314E of the first core 310E extends in a substantially vertical direction beside a right magnetic rod 324 of the second core 320B. The left magnetic rod 315E of the first core 310E extends in a substantially vertical direction beside a left magnetic rod 325 of the second core 320B. Since the first core 310E is aligned with the second core 320B in a depth direction, the designer can give a small dimension value to the coil structure 100E in a horizontal direction. The first coil 210E corresponds to the first coil 210 described with reference to FIG. 1. The second coil 220E corresponds to the second coil 220 described with reference to FIG. 1. The first core 310E corresponds to the first core 310 described with reference to FIG. 1.

The right magnetic rod 314E of the first core 310E penetrates the first coil 210E and the third coil 230B. The right magnetic rod 324 of the second core 320B penetrates the second coil 220E and the third coil 230B. Since the first coil 210E, the second coil 220E, and the third coil 230B are concentrated around the right magnetic rods 314E and 324, the manufacturer of the coil structure 100E may form the first coil 210E, the second coil 220E, and the third coil 230B by using a small bobbin structure (not illustrated).

### Eighth Embodiment

The designer may incorporate three or more primary coils into a coil structure. Use of a large number of primary coils allows a coil structure to receive large power. In the Eighth Embodiment, the design principle of a coil structure having four primary coils is described.

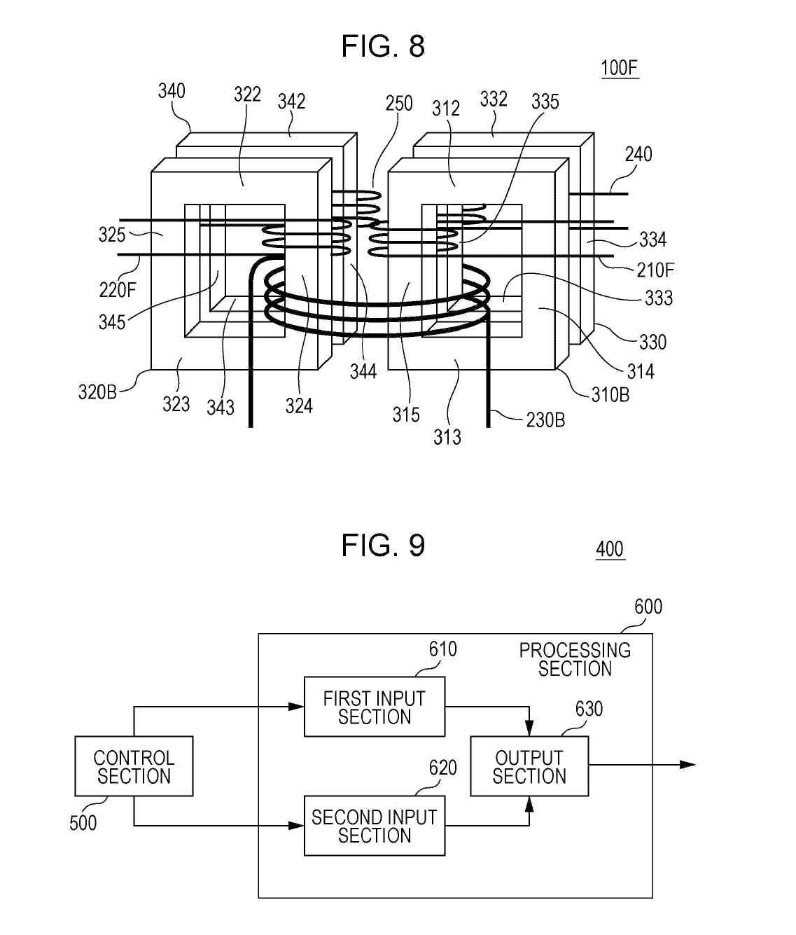

FIG. 8 is a perspective view schematically illustrating a coil structure 100F of the Eighth Embodiment. The coil structure 100F is described with reference to FIGS. 1 and 8. Reference signs common to the Sixth Embodiment and the Eighth Embodiment mean that elements given these reference signs have identical functions to those in the Sixth Embodiment. Therefore, the description in the Sixth Embodiment is applied to these elements.

As in the Sixth Embodiment, the coil structure 100F includes a third coil 230B, a first core 310B, and a second core 320B. The description of the Sixth Embodiment is applied to these elements.

The coil structure 100F further includes a first coil 210F and a second coil 220F. The first coil 210F corresponds to the first coil 210 described with reference to FIG. 1. The second coil 220F corresponds to the second coil 220 described with reference to FIG. 1.

The coil structure 100F further includes a fourth coil 240, a fifth coil 250, a third core 330, and a fourth core 340. As well as the first coil 210F and the second coil 220F, the fourth coil 240 and the fifth coil 250 are used as primary coils. The fourth coil 240 is wound around part of the third core 330. The fifth coil 250 is wound around part of the fourth core 340. As well as the first core 310B and the second core 320B, each of the third core 330 and the fourth core 340 forms a rectangular ring.

The third core 330 includes an upper magnetic rod 332, a lower magnetic rod 333, a right magnetic rod 334, and a left magnetic rod 335. The upper magnetic rod 332 of the third core 330 extends in a substantially horizontal direction beside an upper magnetic rod 312 of the first core 310B. The lower magnetic rod 333 of the third core 330 extends in a substantially horizontal direction beside a lower magnetic rod 313 of the first core 310B. The right magnetic rod 334 of the third core 330 extends in a substantially vertical direction beside a right magnetic rod 314 of the first core 310B. The left magnetic rod 335 of the third core 330 extends in a substantially vertical direction beside a left magnetic rod 315 of the first core 310B.

The fourth core 340 includes an upper magnetic rod 342, a lower magnetic rod 343, a right magnetic rod 344, and a left magnetic rod 345. The upper magnetic rod 342 of the fourth core 340 extends in a substantially horizontal direction beside an upper magnetic rod 322 of the second core 320B. The lower magnetic rod 343 of the fourth core 340 extends in a substantially horizontal direction beside a lower magnetic rod 323 of the second core 320B. The right magnetic rod 344 of the fourth core 340 extends in a substantially vertical direction beside a right magnetic rod 324 of the second core 320B. The left magnetic rod 345 of the fourth core 340 extends in a substantially vertical direction beside a left magnetic rod 325 of the second core 320B.

The left magnetic rod 315 of the first core 310B penetrates the first coil 210F and the third coil 230B. The right magnetic rod 324 of the second core 320B penetrates the second coil 220F and the third coil 230B. The left magnetic rod 335 of the third core 330 penetrates the fourth coil 240 and the third coil 230B. The right magnetic rod 344 of the fourth core 340 penetrates the fifth coil 250 and the third coil 230B. In the present embodiment, a fifth penetrating section is exemplified by the left magnetic rod 335 of the third core 330.

The left magnetic rod 315 of the first core 310B is separated from the right magnetic rod 324 of the second core 320B, the left magnetic rod 335 of the third core 330, and the right magnetic rod 344 of the fourth core 340. The right magnetic rod 324 of the second core 320B is separated from the left magnetic rod 315 of the first core 310B, the left magnetic rod 335 of the third core 330, and the right magnetic rod 344 of the fourth core 340. The left magnetic rod 335 of the third core 330 is separated from the left magnetic rod 315 of the first core 310B, the right magnetic rod 324 of the second core 320B, and the right magnetic rod 344 of the fourth core 340. The right magnetic rod 344 of the fourth core 340 is separated from the left magnetic rod 315 of the first core 310B, the right magnetic rod 324 of the second core 320B, and the left magnetic rod 335 of the third core 330.

### Ninth Embodiment

The coil structures described in association with the First Embodiment through the Eighth Embodiment are suitably applicable to a power source device. In the Ninth Embodiment, a power source device is described.

FIG. 9 is a block diagram schematically illustrating a power source device 400 of the Ninth Embodiment. The power source device 400 is described with reference to FIG. 9.

The power source device 400 includes a control section 500 and a processing section 600. The processing section 600 outputs power under control of the control section 500.

The processing section 600 includes a first input section 610, a second input section 620, and an output section 630. The control section 500 controls the first input section 610 and the second input section 620 to generate a pulsating voltage. The output section 630 outputs power in accordance with generation of a pulsating voltage.

The first coil described in association with the First Embodiment through the Eighth Embodiment is allocated to the first input section 610. The second coil described in association with the First Embodiment through the Eighth Embodiment is allocated to the second input section 620. The third coil described in association with the First Embodiment through the Eighth Embodiment is allocated to the output section 630. Therefore, the circuit structure of the processing section 600 may be a general circuit that outputs power by using a transformer. The principle of the present embodiment is not limited to a specific circuit structure of the processing section 600.

### Tenth Embodiment

The power source device described in association with the Ninth Embodiment can output power under various controls. In the Tenth Embodiment, an exemplary technique for controlling a power source device is described.

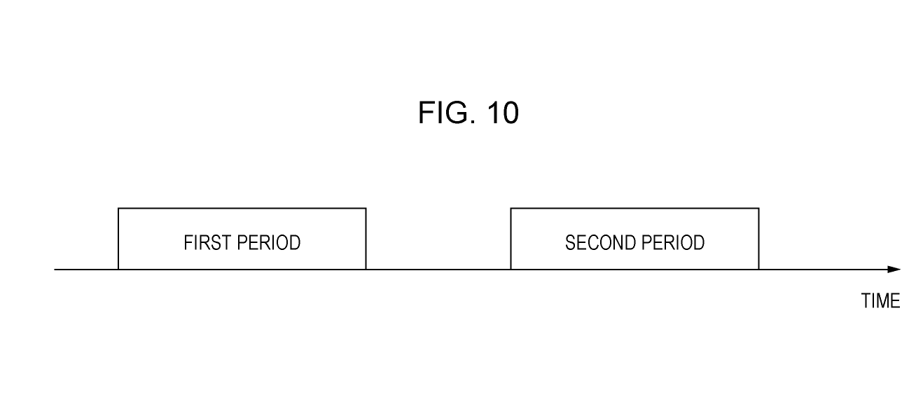

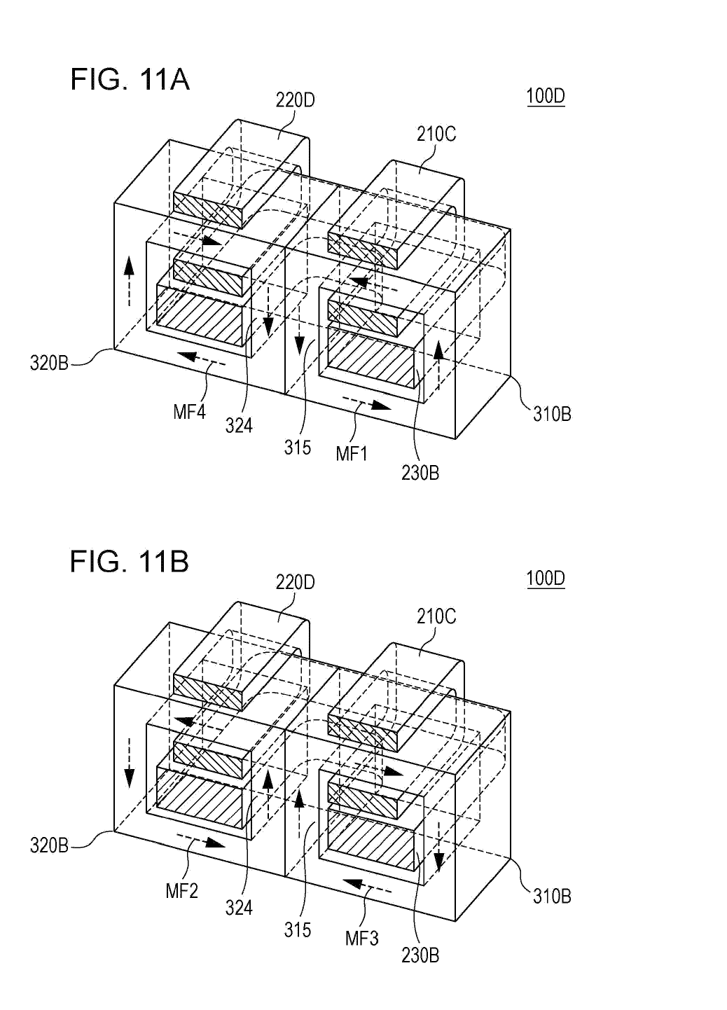

FIG. 10 is a timing diagram schematically illustrating the concept of control of a power source device 400. FIGS. 11A and 11B are perspective cross-sectional views each schematically illustrating the coil structure 100D described in association with the Sixth Embodiment. Control of the power source device 400 is described with reference to FIGS. 9 through 11B.

In the present embodiment, the coil structure 100D is incorporated in the power source device 400. A first input section 610 includes a first coil 210C. A second input section 620 includes a second coil 220D. An output section 630 includes a third coil 230B.

A control section 500 set a first period and a second period. The second period does not overlap the first period. The first period and the second period may be alternately repeated.

The control section 500 controls the first input section 610 during the first period to supply power to the first coil 210C. As a result, a counterclockwise magnetic flux MF1 occurs in a first core 310B. The control section 500 controls the second input section 620 during the second period to supply power to the second coil 220D. As a result, a counterclockwise magnetic flux MF2 occurs in a second core 320B. In the present embodiment, a first magnetic flux is exemplified by the magnetic flux MF1. A second magnetic flux is exemplified by the magnetic flux MF2.

As illustrated in FIG. 11A, the magnetic flux MF1 flows downward along a left magnetic rod 315 of the first core 310B. As illustrated in FIG. 11B, the magnetic flux MF2 flows upward along a right magnetic rod 324 of the second core 320B. Since there is an interval between the first period and the second period as described above, it is hard for the magnetic flux MF1 to be canceled out by the magnetic flux MF2. Therefore, the power source device 400 can achieve high power supply efficiency. In the present embodiment, a first direction may be a downward direction. A second direction may be an upward direction.

The control section 500 controls the first input section 610 during the second period to switch a direction of an electric current flowing through the first coil 210C. As a result, a clockwise magnetic flux MF3 occurs in the first core 310B. As illustrated in FIG. 11B, the magnetic flux MF3 flows upward along the left magnetic rod 315 of the first core 310B. In the present embodiment, a third magnetic flux is exemplified by the magnetic flux MF3.

The control section 500 controls the second input section 620 during the first period to switch a direction of an electric current flowing through the second coil 220D. As a result, a clockwise magnetic flux MF4 occurs in the second core 320B. As illustrated in FIG. 11A, the magnetic flux MF4 flows downward along the right magnetic rod 324 of the second core 320B. In the present embodiment, a fourth magnetic flux is exemplified by the magnetic flux MF4.

### Eleventh Embodiment

The designer can design various control circuits for a power source device. In the Eleventh Embodiment, an exemplary circuit of a power source device is described.

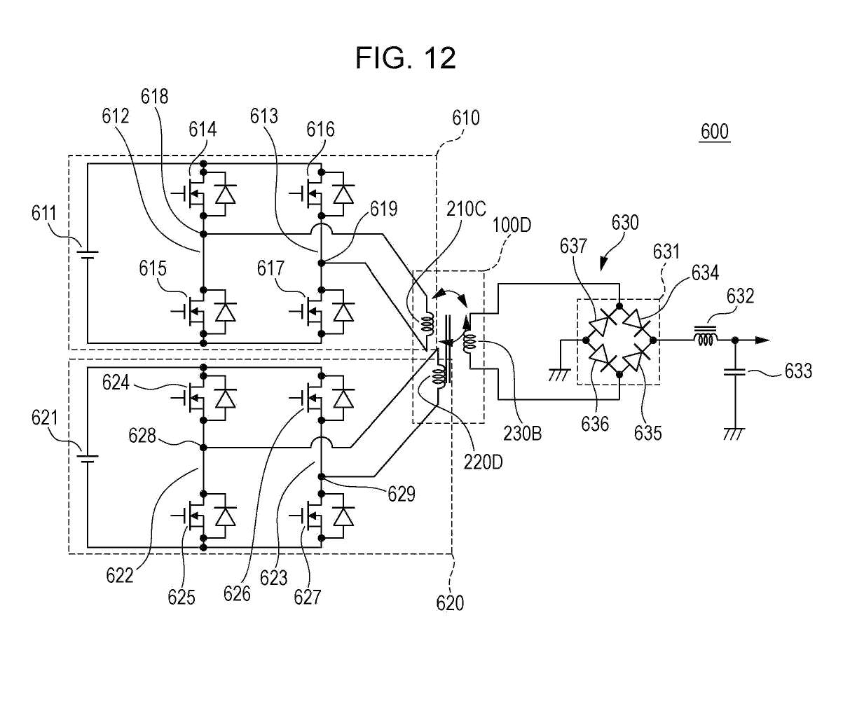

FIG. 12 is a circuit diagram schematically illustrating a processing section 600 of a power source device 400. Control of the power source device 400 is described with reference to FIGS. 9, and 11A through 12.

In the present embodiment, a coil structure 100D is incorporated in the power source device 400. A first input section 610 includes a first coil 210C. A second input section 620 includes a second coil 220D. An output section 630 includes a third coil 230B.

The first input section 610 includes a first power source 611, a first switch circuit section 612, and a second switch circuit section 613. The first power source 611 outputs direct-current power. The first switch circuit section 612 is connected in parallel with the first power source 611. The second switch circuit section 613 is connected in parallel with the first power source 611 and the first switch circuit section 612. In the present embodiment, first direct-current power is exemplified by the direct-current power outputted by the first power source 611.

The first switch circuit section 612 includes a first switch element 614 and a second switch element 615. The second switch element 615 is connected in series with the first switch element 614. The control section 500 controls the first switch element 614 and the second switch element 615.

The second switch circuit section 613 includes a third switch element 616 and a fourth switch element 617. The fourth switch element 617 is connected in series with the third switch element 616. The control section 500 controls the third switch element 616 and the fourth switch element 617.

The first switch circuit section 612 includes a first connection point 618 between the first switch element 614 and the second switch element 615. The second switch circuit section 613 includes a second connection point 619 between the third switch element 616 and the fourth switch element 617. The first coil 210C is connected to the first connection point 618 and the second connection point 619.

The control section 500 can control the first switch element 614, the second switch element 615, the third switch element 616, and the fourth switch element 617 to supply power to the first coil 210C. The control section 500 can control the first switch element 614, the second switch element 615, the third switch element 616, and the fourth switch element 617 to properly switch a direction of an electric current flowing through the first coil 210C.

The second input section 620 includes a second power source 621, a third switch circuit section 622, and a fourth switch circuit section 623. The second power source 621 outputs direct-current power. The third switch circuit section 622 is connected in parallel with the second power source 621. The fourth switch circuit section 623 is connected in parallel with the second power source 621 and the third switch circuit section 622. In the present embodiment, second direct-current power is exemplified by the direct-current power outputted by the second power source 621.

The third switch circuit section 622 includes a fifth switch element 624 and a sixth switch element 625. The sixth switch element 625 is connected in series with the fifth switch element 624. The control section 500 controls the fifth switch element 624 and the sixth switch element 625.

The fourth switch circuit section 623 includes a seventh switch element 626 and an eighth switch element 627. The eighth switch element 627 is connected in series with the seventh switch element 626. The control section 500 controls the seventh switch element 626 and the eighth switch element 627.

The third switch circuit section 622 includes a third connection point 628 between the fifth switch element 624 and the sixth switch element 625. The second switch circuit section 613 includes a fourth connection point 629 between the seventh switch element 626 and the eighth switch element 627. The second coil 220D is connected to the third connection point 628 and the fourth connection point 629.

The control section 500 can control the fifth switch element 624, the sixth switch element 625, the seventh switch element 626, and the eighth switch element 627 to supply power to the second coil 220D. The control section 500 can control the fifth switch element 624, the sixth switch element 625, the seventh switch element 626, and the eighth switch element 627 to properly switch a direction of an electric current flowing through the second coil 220D.

The output section 630 includes a bridge circuit 631, a choke coil 632, and a smoothing capacitor 633. The bridge circuit 631 includes four diodes 634, 635, 636, and 637. The bridge circuit 631 is connected to the third coil 230B. Power supply to the first coil 210C and/or the second coil 220D generates an induced electric current in the third coil 230B. The induced electric current flows into the bridge circuit 631. The bridge circuit 631 rectifies the induced electric current.

The choke coil 632 is connected to the bridge circuit 631 and the smoothing capacitor 633. The electric current rectified by the bridge circuit 631 is outputted through the choke coil 632. The smoothing capacitor 633 reduces a fluctuation in output voltage.

### Twelfth Embodiment

The power source device described in association with the Eleventh Embodiment can output power under various controls. In the Twelfth Embodiment, an exemplary technique for controlling a power source device is described.

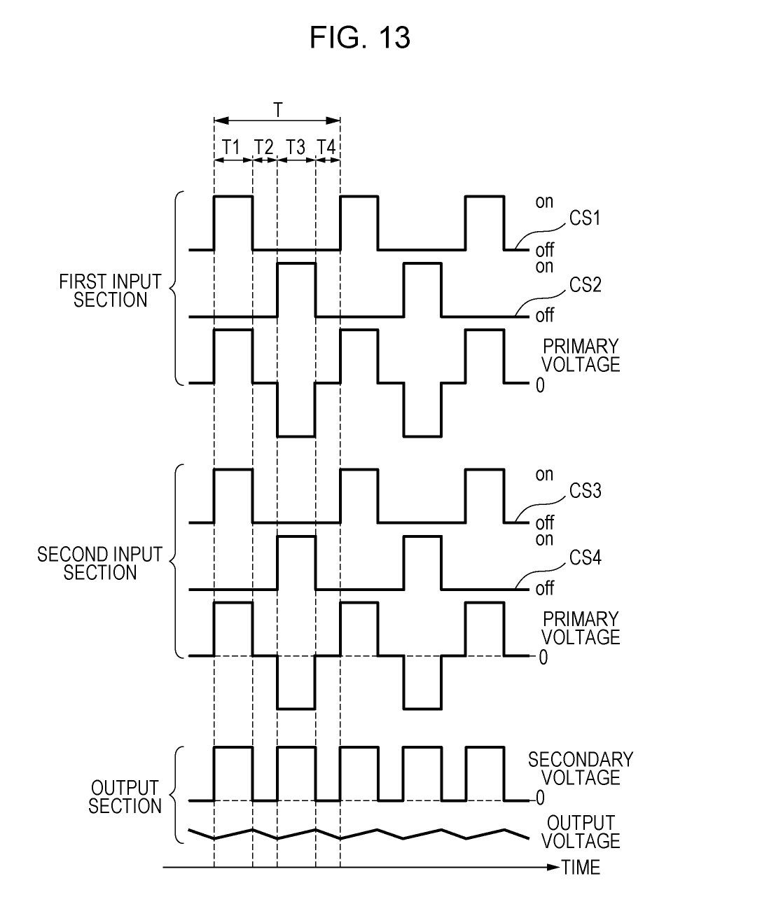

FIG. 13 is a timing diagram schematically showing the concept of control of a power source device 400. Control of the power source device 400 is described with reference to FIGS. 9, and 11A through 13.

FIG. 13 shows a first control signal CS1 and a second control signal CS2. A control section 500 generates the first control signal CS1 and the second control signal CS2. The first control signal CS1 and the second control signal CS2 are supplied from the control section 500 to a first input section 610.

Each of the first control signal CS1 and the second control signal CS2 includes a plurality of pulse signals. In FIG. 13, an output cycle of a pulse signal is indicated by the sign “T”. In the following description, a period from a rise time to a fall time of each pulse signal is referred to as an “ON period”. The other period is referred to as an “OFF period”.

A first switch element 614 and a fourth switch element 617 operate in accordance with the first control signal CS1. During the ON period, the first switch element 614 and the fourth switch element 617 permit passage of an electric current. During the OFF period, the first switch element 614 and the fourth switch element 617 block passage of an electric current. In FIG. 13, the ON period of the first switch element 614 and the fourth switch element 617 is indicated by the sign “T1”.

A second switch element 615 and a third switch element 616 operate in accordance with the second control signal CS2. During the ON period, the second switch element 615 and the third switch element 616 permit passage of an electric current. During the OFF period, the second switch element 615 and the third switch element 616 block passage of an electric current. In FIG. 13, the ON period of the second switch element 615 and the third switch element 616 is indicated by the sign “T3”.

The control section 500 sets the ON period “T3” of the second switch element 615 and the third switch element 616 after a period “T2” from the end of the ON period “T2” of the first switch element 614 and the fourth switch element 617. The control section 500 sets the ON period “T1” of the first switch element 614 and the fourth switch element 617 after a period “T4” from the end of the ON period “T3” of the second switch element 615 and the third switch element 616. Accordingly, the ON period “T1” of the first switch element 614 and the fourth switch element 617 does not overlap in time the ON period “T3” of the second switch element 615 and the third switch element 616.

During the ON period “T1”, the first switch element 614 and the fourth switch element 617 permit passage of an electric current. Accordingly, the electric current sequentially pass a first power source 611, the first switch element 614, a first coil 210C, and the fourth switch element 617, and finally returns to the first power source 611. Since the electric current flows into the first coil 210C, a magnetic flux MF1 occurs in a first core 310B as described with reference to FIG. 11A. The ON period “T1” may correspond to the first period described with reference to FIG. 11A.

During the period “T2”, the first switch element 614, the second switch element 615, the third switch element 616, and the fourth switch element 617 block passage of an electric current. Accordingly, power is not supplied to the first coil 210C.

During the ON period “T3”, the second switch element 615 and the third switch element 616 permit passage of an electric current. Accordingly, the electric current passes the first power source 611, the third switch element 616, the first coil 210C, and the second switch element 615, and finally returns to the first power source 611. That is, the direction of the electric current flowing through the first coil 210C during the ON period “T3” is opposite to the direction of the electric current flowing through the first coil 210C during the ON period “T1”.

Since the electric current flowing in the direction opposite to the direction of the electric current flowing during the ON period “T1” flows into the first coil 210C, a magnetic flux MF3 occurs in the first core 310B as described with reference to FIG. 11B. The ON period “T3” may correspond to the second period described with reference to FIG. 11B.

During the period “T4”, the first switch element 614, the second switch element 615, the third switch element 616, and the fourth switch element 617 block passage of an electric current. Accordingly, power is not supplied to the first coil 210C.

FIG. 13 shows a fluctuation of a primary voltage applied to the first coil 210C. As illustrated in FIG. 13, the polarity of the primary voltage is inverted between the ON periods “T1” and “T3”.

FIG. 13 shows a third control signal CS3 and a fourth control signal CS4. The control section 500 generates the third control signal CS3 and the fourth control signal CS4. The third control signal CS3 and the fourth control signal CS4 are supplied from the control section 500 to a second input section 620.

The third control signal CS3 includes a plurality of pulse signals that synchronize with the plurality of pulse signals of the first control signal CS1. The fourth control signal CS4 includes a plurality of pulse signals that synchronize with the plurality of pulse signals of the second control signal CS2.

The fifth switch element 624 and the eighth switch element 627 operate in accordance with the third control signal CS3. During the ON period, the fifth switch element 624 and the eighth switch element 627 permit passage of an electric current. During the OFF period, the fifth switch element 624 and the eighth switch element 627 block passage of an electric current. In FIG. 13, the ON period of the fifth switch element 624 and the eighth switch element 627 is indicated by the sign “T1”.

The sixth switch element 625 and the seventh switch element 626 operate in accordance with the fourth control signal CS4. During the ON period, the sixth switch element 625 and the seventh switch element 626 permit passage of an electric current. During the OFF period, the sixth switch element 625 and the seventh switch element 626 block passage of an electric current. In FIG. 13, the ON period of the sixth switch element 625 and the seventh switch element 626 is indicated by the sign “T3”.

The control section 500 sets the ON period “T3” of the sixth switch element 625 and the seventh switch element 626 after a period “T2” from the end of the ON period “T1” of the fifth switch element 624 and the eighth switch element 627. The control section 500 sets the ON period “T1” of the fifth switch element 624 and the eighth switch element 627 after a period “T4” from the end of the ON period “T3” of the sixth switch element 625 and the seventh switch element 626. Accordingly, the ON period “T1” of the fifth switch element 624 and the eighth switch element 627 does not overlap in time the ON period “T3” of the sixth switch element 625 and the seventh switch element 626.

During the ON period “T1”, the fifth switch element 624 and the eighth switch element 627 permit passage of an electric current. Accordingly, the electric current sequentially passes a second power source 621, the fifth switch element 624, a second coil 220D, and the eighth switch element 627, and finally returns to the second power source 621. Since the electric current flows into the second coil 220D, a magnetic flux MF4 occurs in a second core 320B as described with reference to FIG. 11A.

During the period “T2”, the fifth switch element 624, the sixth switch element 625, the seventh switch element 626, and the eighth switch element 627 block passage of an electric current. Accordingly, power is not supplied to the second coil 220D.

During the ON period “T3”, the sixth switch element 625 and the seventh switch element 626 permit passage of an electric current. Accordingly, the electric current pass the second power source 621, the seventh switch element 626, the second coil 220D, and the sixth switch element 625, and finally returns to the second power source 621. That is, the direction of the electric current flowing through the first coil 210C during the ON period “T3” is opposite to the direction of the electric current flowing through the first coil 210C during the ON period “T1”.

Since the electric current flowing in the direction opposite to the direction of the electric current flowing during the ON period “T1” flows into the second coil 220D, a magnetic flux MF2 occurs in the second core 320B as described with reference to FIG. 11B. The ON period “T3” may correspond to the second period described with reference to FIG. 11B.

During the period “T4”, the fifth switch element 624, the sixth switch element 625, the seventh switch element 626, and the eighth switch element 627 block passage of an electric current. Accordingly, power is not supplied to the second coil 220D.

FIG. 13 shows a fluctuation of a primary voltage applied to the second coil 220D. As illustrated in FIG. 13, the polarity of the primary voltage is inverted between the ON periods “T1” and “T3”.

FIG. 13 shows a fluctuation of a secondary voltage outputted from a bridge circuit 631 and a fluctuation of an output voltage outputted from the power source device 400. As described in associated with FIG. 11A, the magnetic flux MF1 occurring in the first core 310B and the magnetic flux MF4 occurring in the second core 320B pass a third coil 230B without canceling out each other. Therefore, during the ON period “Ti”, the bridge circuit 631 can output a high secondary voltage. As described in associated with FIG. 11B, the magnetic flux MF3 occurring in the first core 310B and the magnetic flux MF2 occurring in the second core 320B pass the third coil 230B without canceling out each other. Therefore, during the ON period “T3”, the bridge circuit 631 can output a high secondary voltage.

A choke coil 632 and a smoothing capacitor 633 smooth the secondary voltage. As a result, the power source device 400 can output high direct-current power.

As described above, the coil structure 100D can synthesize a magnetic flux occurring in the first input section 610 and a magnetic flux occurring in the second input section 620. Therefore, even in a case where the level of a voltage used in the first input section 610 and the second input section 620 is low, the power source device 400 can output a high voltage. This allows a designer to design the power source device 400 by using small magnetic cores and small coils.

Since the power source device 400 permits a low input voltage, the designer of the power source device 400 may use inexpensive electronic parts as the first input section 610 and the second input section 620. The designer may use an MOSFET as the first switch element 614, the second switch element 615, the third switch element 616, the fourth switch element 617, the fifth switch element 624, the sixth switch element 625, the seventh switch element 626, and the eighth switch element 627. Alternatively, the designer may use an IGBT or a power switch element, such as GaN or SIC, using a wide gap material as the first switch element 614, the second switch element 615, the third switch element 616, the fourth switch element 617, the fifth switch element 624, the sixth switch element 625, the seventh switch element 626, and the eighth switch element 627.

It is known that the direction of flow of a magnetic flux depends on a direction in which a wire rod used as a coil is wound. An output pattern of a pulse signal from the control section 500 is determined in accordance with the direction in which the wire rod is wound. Therefore, the principle of the present embodiment is not limited to a specific output pattern of a pulse signal.

### Thirteenth Embodiment

A designer can design various control circuits for a power source device. In the Thirteenth Embodiment, an exemplary circuit of a power source device is described.

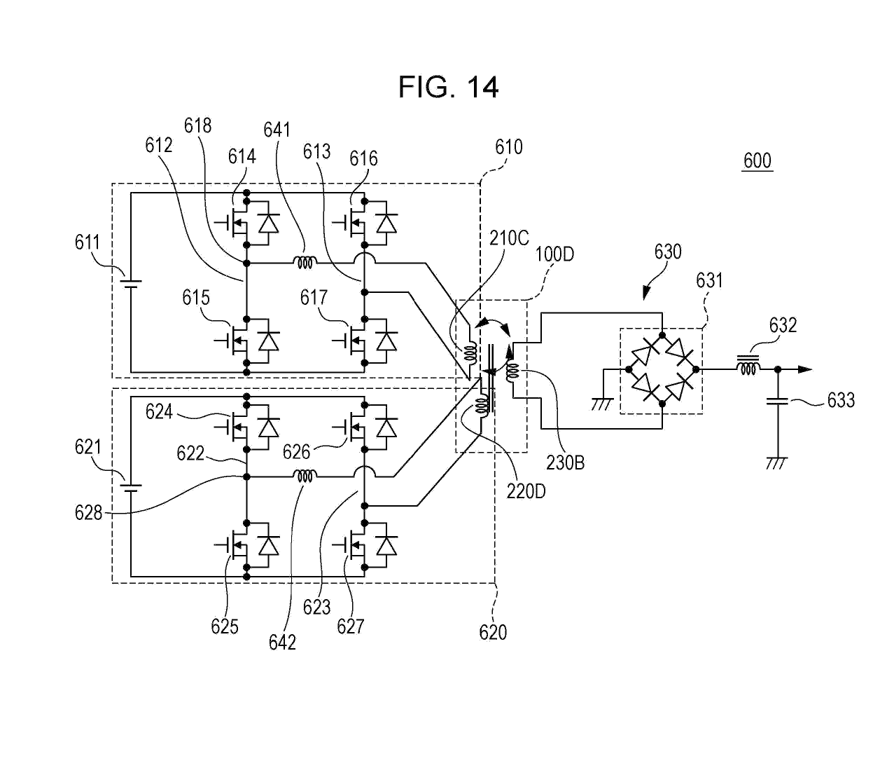

FIG. 14 is a circuit diagram schematically illustrating a processing section 600 of a power source device 400. Control of the power source device 400 is described with reference to FIGS. 9, 11A, 11B, and 14. Reference signs common to the Eleventh Embodiment and the Thirteenth Embodiment mean that elements given these reference signs have identical functions to those in the Eleventh Embodiment. Therefore, the description in the Eleventh Embodiment is applied to these elements.

As in the Eleventh Embodiment, a coil structure 100D is incorporated in the power source device 400. A first input section 610 includes a first coil 210C. A second input section 620 includes a second coil 220D. An output section 630 includes a third coil 230B.

As in the Eleventh Embodiment, the first input section 610 includes a first power source 611, a first switch circuit section 612, and a second switch circuit section 613. The description of the Eleventh Embodiment is applied to these elements.

As in the Eleventh Embodiment, the second input section 620 includes a second power source 621, a third switch circuit section 622, and a fourth switch circuit section 623. The description of the Eleventh Embodiment is applied to these elements.

As in the Eleventh Embodiment, the output section 630 includes a bridge circuit 631, a choke coil 632, and a smoothing capacitor 633. The description of the Eleventh Embodiment is applied to these elements.

The first input section 610 further includes a first leakage inductor 641. The first leakage inductor 641 is connected to a first connection point 618 and the first coil 210C. That is, the first coil 210C is connected to the first connection point 618 via the first leakage inductor 641.

The second input section 620 further includes a second leakage inductor 642. The second leakage inductor 642 is connected to a third connection point 628 and the second coil 220D. That is, the second coil 220D is connected to the third connection point 628 via the second leakage inductor 642.

### Fourteenth Embodiment

The power source device described in association with the Thirteenth Embodiment can output power under various controls. In the Fourteenth Embodiment, an exemplary technique for controlling a power source device is described.

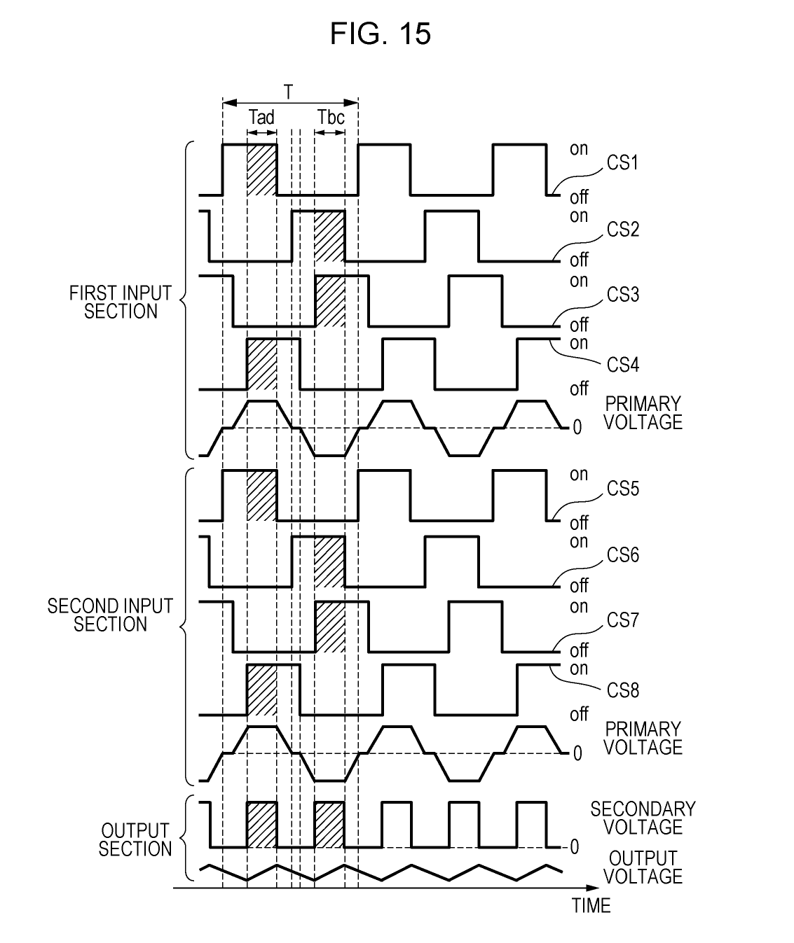

FIG. 15 is a timing diagram schematically showing the concept of control of a power source device 400. Control of the power source device 400 is described with reference to FIGS. 9, 11A, 11B, and 13 through 15.

FIG. 15 shows a first control signal CS1, a second control signal CS2, a third control signal CS3, and a fourth control signal CS4. A control section 500 generates the first control signal CS1, the second control signal CS2, the third control signal CS3, and the fourth control signal CS4. The first control signal CS1, the second control signal CS2, the third control signal CS3, and the fourth control signal CS4 are supplied from the control section 500 to a first input section 610.

Each of the first control signal CS1, the second control signal CS2, the third control signal CS3, and the fourth control signal CS4 includes a plurality of pulse signals. In FIG. 15, an output cycle of a pulse signal is indicated by the sign “T”. In the following description, a period from a rise time to a fall time of each pulse signal is referred to as an “ON period”. The other period is referred to as an “OFF period”.

A first switch element 614 operates in accordance with the first control signal CS1. During the ON period, the first switch element 614 permits passage of an electric current. During the OFF period, the first switch element 614 blocks passage of an electric current.

A second switch element 615 operates in accordance with the second control signal CS2. During the ON period, the second switch element 615 permits passage of an electric current. During the OFF period, the second switch element 615 blocks passage of an electric current.

A third switch element 616 operates in accordance with the third control signal CS3. During the ON period, the third switch element 616 permits passage of an electric current. During the OFF period, the third switch element 616 blocks passage of an electric current.

A fourth switch element 617 operates in accordance with the fourth control signal CS4. During the ON period, the fourth switch element 617 permits passage of an electric current. During the OFF period, the fourth switch element 617 blocks passage of an electric current.

The control section 500 generates the second control signal CS2 so that the ON period defined by the second control signal CS2 does not overlap the ON period defined by the first control signal CS1. The control section 500 generates the fourth control signal CS4 so that the ON period defined by the fourth control signal CS4 does not overlap the ON period defined by the third control signal CS3.

The control section 500 generates the fourth control signal CS4 so that the ON period defined by the fourth control signal CS4 does not overlap the ON period defined by the first control signal CS1. The ON period defined by the fourth control signal CS4 starts later than the ON period defined by the first control signal CS1. The ON period defined by the fourth control signal CS4 ends later than the ON period defined by the first control signal CS1.

The control section 500 generates the third control signal CS3 so that the ON period defined by the third control signal CS3 overlaps the ON period defined by the second control signal CS2. The ON period defined by the third control signal CS3 starts later than the ON period defined by the second control signal CS2. The ON period defined by the third control signal CS3 ends later than the ON period defined by the second control signal CS2.

In FIG. 15, an overlapping period in which the ON period defined by the first control signal CS1 and the ON period defined by the fourth control signal CS4 overlap each other is indicated by the sign “Tad”. During the overlapping period “Tad”, energy is accumulated in a first leakage inductor 641. When the OFF period of the first switch element 614 starts, energy in the first leakage inductor 641 is discharged. As a result, an electric current sequentially passes the first leakage inductor 641, a first coil 210C, a parasitic diode of the fourth switch element 617, and a parasitic diode of the second switch element 615, and finally returns to the first leakage inductor 641.

After a voltage applied to the second switch element 615 becomes “0”, the ON period of the second switch element 615 starts. Then, the OFF period of the fourth switch element 617 starts.

In FIG. 15, an overlapping period in which the ON period defined by the second control signal CS2 and the ON period defined by the third control signal CS3 overlap each other is indicated by the sign “Tbc”. During the overlapping period “Tbc”, energy is accumulated in the first leakage inductor 641. When the OFF period of the second switch element 615 starts, the energy in the first leakage inductor 641 is discharged. As a result, an electric current sequentially passes the first leakage inductor 641, the first coil 210C, a parasitic diode of the third switch element 616, and the first power source 611, and finally returns to the first leakage inductor 641.

After a voltage applied to the second switch element 615 becomes “0”, the ON period of the second switch element 615 starts. As in the case of the second switch element 615, each of the first switch element 614, the third switch element 616, and the fourth switch element 617 shifts to an ON mode after a voltage applied thereto becomes “0”.

FIG. 15 shows a fluctuation of a primary voltage applied to the first coil 210C. As a result of the aforementioned soft switching operation, a switching loss is reduced. Accordingly, the primary voltage shown in FIG. 15 fluctuates more gradually than the primary voltage shown in FIG. 13.

FIG. 15 shows a fifth control signal CS5, a sixth control signal CS6, a seventh control signal CS7, and an eighth control signal CS8. The control section 500 generates the fifth control signal CS5, the sixth control signal CS6, the seventh control signal CS7, and the eighth control signal CS8. The fifth control signal CS5, the sixth control signal CS6, the seventh control signal CS7, and the eighth control signal CS8 are supplied from the control section 500 to a second input section 620. Each of the fifth control signal CS5, the sixth control signal CS6, the seventh control signal CS7, and the eighth control signal CS8 includes a plurality of pulse signals.

A fifth switch element 624 operates in accordance with the fifth control signal CS5. During the ON period, the fifth switch element 624 permits passage of an electric current. During the OFF period, the fifth switch element 624 blocks passage of an electric current.

A sixth switch element 625 operates in accordance with the sixth control signal CS6. During the ON period, the sixth switch element 625 permits passage of an electric current. During the OFF period, the sixth switch element 625 blocks passage of an electric current.

A seventh switch element 626 operates in accordance with the seventh control signal CS7. During the ON period, the seventh switch element 626 permits passage of an electric current. During the OFF period, the seventh switch element 626 blocks passage of an electric current.

An eighth switch element 627 operates in accordance with the eighth control signal CS8. During the ON period, the eighth switch element 627 permits passage of an electric current. During the OFF period, the eighth switch element 627 blocks passage of an electric current.

The control section 500 generates the sixth control signal CS6 so that the ON period defined by the sixth control signal CS6 does not overlap the ON period defined by the fifth control signal CS5. The control section 500 generates the eighth control signal CS8 so that the ON period defined by the eighth control signal CS8 does not overlap the ON period defined by the seventh control signal CS7.

The control section 500 generates the eighth control signal CS8 so that the ON period defined by the eighth control signal CS8 overlaps the ON period defined by the fifth control signal CS5. The ON period defined by the eighth control signal CS8 starts later than the ON period defined by the fifth control signal CS5. The ON period defined by the eighth control signal CS8 ends later than the ON period defined by the fifth control signal CS5.

The control section 500 generates the seventh control signal CS7 so that the ON period defined by the seventh control signal CS7 overlaps the ON period defined by the sixth control signal CS6. The ON period defined by the seventh control signal CS7 starts later than the ON period defined by the sixth control signal CS6. The ON period defined by the seventh control signal CS7 ends later than the ON period defined by the sixth control signal CS6.

In FIG. 15, an overlapping period in which the ON period defined by the fifth control signal CS5 and the ON period defined by the eighth control signal CS8 overlap each other is indicated by the sign “Tad”. During the overlapping period “Tad”, energy is accumulated in a second leakage inductor 642. When the OFF period of the fifth switch element 624 starts, the energy in the second leakage inductor 642 is discharged. As a result, an electric current sequentially passes the second leakage inductor 642, the second coil 220D, a parasitic diode of the eighth switch element 627, and a parasitic diode of the sixth switch element 625, and finally returns to the second leakage inductor 642.

After a voltage applied to the sixth switch element 625 becomes “0”, the ON period of the sixth switch element 625 starts. Then, the OFF period of the eighth switch element 627 starts.

In FIG. 15, an overlapping period in which the ON period defined by the sixth control signal CS6 and the ON period defined by the seventh control signal CS7 overlap each other is indicated by the sign “Tbc”. During the overlapping period “Tbc”, energy is accumulated in the second leakage inductor 642. When the OFF period of the sixth switch element 625 starts, the energy in the second leakage inductor 642 is discharged. As a result, an electric current sequentially passes the second leakage inductor 642, the second coil 220D, a parasitic diode of the seventh switch element 626, and the second power source 621, and finally returns to the second leakage inductor 642.

After a voltage applied to the sixth switch element 625 becomes “0”, the ON period of the sixth switch element 625 starts. As in the case of the sixth switch element 625, each of the fifth switch element 624, the seventh switch element 626, and the eighth switch element 627 shifts to an ON mode after a voltage applied thereto becomes “0”.

FIG. 15 shows a fluctuation of a primary voltage applied to the second coil 220D. As a result of the aforementioned soft switching operation, a switching loss is reduced. Accordingly, the primary voltage shown in FIG. 15 fluctuates more gradually than the primary voltage shown in FIG. 13.

FIG. 15 shows a fluctuation of a secondary voltage outputted from a bridge circuit 631 and a fluctuation of a secondary voltage outputted from the power source device 400. As described in association with FIG. 11A, a magnetic flux MF1 occurring in the first core 310B and a magnetic flux MF4 occurring in the second core 320B pass a third coil 230B without canceling out each other. Accordingly, the bridge circuit 631 can output a high secondary voltage. As described in association with FIG. 11B, a magnetic flux MF3 occurring in the first core 310B and a magnetic flux MF2 occurring in the second core 320B pass the third coil 230B without canceling out each other. Accordingly, the bridge circuit 631 can output a high secondary voltage.

A choke coil 632 and a smoothing capacitor 633 smooth the secondary voltage. As a result, the power source device 400 can output high direct-current power.

As described above, the coil structure 100D can synthesize a magnetic flux occurring in the first input section 610 and a magnetic flux occurring in the second input section 620. Therefore, even in a case where the level of a voltage used in the first input section 610 and the second input section 620 is low, the power source device 400 can output a high voltage.

The principles in the above various embodiments may be combined in conformity with use of a coil structure and/or a power source device and properties requested for the coil structure and/or the power source device.

The principles in the above embodiments are suitably applicable to various devices utilizing electromagnetic induction.

What is claimed is:

1. A coil structure comprising:
a first coil that is a first primary coil;
a second coil that is a second primary coil;
a first core around which the first coil is wound, the first core having an annular shape;
a second core around which the second coil is wound, the second core having an annular shape; and
a third coil that is a secondary coil,
the first core including a first penetrating section that penetrates the third coil,
the second core including a second penetrating section that penetrates the third coil,
the first penetrating section being separated from the second penetrating section.

2. The coil structure according to claim 1, further comprising an insulating member located between the first penetrating section and the second penetrating section.

3. The coil structure according to claim 1, wherein:
the third coil is located between the first coil and the second coil.

4. The coil structure according to claim 1, wherein:
the first core includes a third penetrating section that penetrates the first coil;
the first penetrating section includes a first connection end connected to the third penetrating section and a first opposite end that is opposite to the first connection end;
the second core includes a fourth penetrating section that penetrates the second coil;
the second penetrating section includes a second connection end connected to the fourth penetrating section and a second opposite end that is opposite to the second connection end; and
a distance between the first connection end and the second connection end is longer than a distance between the first opposite end and the second connection end.

5. The coil structure according to claim 1, wherein:
the first core includes a third penetrating section that penetrates the first coil;
the first penetrating section includes a first connection end connected to the third penetrating section and a first opposite end that is opposite to the first connection end;
the second core includes a fourth penetrating section that penetrates the second coil;
the second penetrating section includes a second connection end connected to the fourth penetrating section and a second opposite end that is opposite to the second connection end; and
a distance between the first connection end and the second connection end is shorter than a distance between the first connection end and the second opposite end.

6. The coil structure according to claim 1, wherein:
the first penetrating section is separated by 0.2 mm or more from the second penetrating section.

7. The coil structure according to claim 1, further comprising:
a fourth coil that is a third primary coil; and
a third core around which the fourth coil is wound, the first core having an annular shape,
the third core including a fifth penetrating section that penetrates the third coil, and
the fifth penetrating section being separated from the first penetrating section and the second penetrating section.

8. A power source device comprising:
a coil structure comprising: a first coil that is a first primary coil; a second coil that is a second primary coil; a first core around which the first coil is wound, the first core having an annular shape; a second core around which the second coil is wound, the second core having an annular shape; and a third coil that is a secondary coil, the first core including a first penetrating section that penetrates the third coil, the second core including a second penetrating section that penetrates the third coil, the first penetrating section being separated from the second penetrating section;
a first input section comprising the first coil;
a second input section comprising the second coil;
an output section comprising the third coil; and
a control section operative to control the first input section and the second input section.

9. The power source device according to claim 8, wherein:
the control section sets a first period in which the control section causes the first input section to generate a first magnetic flux flowing along the first penetrating section in a first direction and a second period in which the control section causes the second input section to generate a second magnetic flux flowing along the second penetrating section in a second direction opposite to the first direction; and
the second period is separated from the first period.

10. The power source device according to claim 9, wherein:
during the second period, the control section causes the first input section to generate a third magnetic flux flowing along the first penetrating section in the second direction.

11. The power source device according to claim 9, wherein:
during the first period, the control section causes the second input section to generate a fourth magnetic flux flowing along the second penetrating section in the first direction.

12. The power source device according to claim 8, wherein:
the first input section includes a first power source that outputs first direct-current power, a first switch circuit section connected in parallel with the first power source, and a second switch circuit section connected in parallel with the first power source and the first switch circuit section;
the first switch circuit section includes a first switch element and a second switch element connected in series with the first switch element;
the second switch circuit section includes a third switch element and a fourth switch element connected in series with the third switch element;
the first coil is connected to a first connection point between the first switch element and the second switch element and to a second connection point between the third switch element and the fourth switch element; and
the control section controls the first switch element, the second switch element, the third switch element, and the fourth switch element.

13. The power source device according to claim 12, wherein:
the second input section includes a second power source that supplies second direct-current power, a third switch circuit section connected in parallel with the second power source, and a fourth switch circuit section connected in parallel with the second power source and the third switch circuit section;
the third switch circuit section includes a fifth switch element and a sixth switch element connected in series with the fifth switch element;
the fourth switch circuit section includes a seventh switch element and an eighth switch element connected in series with the seventh switch element;
the second coil is connected to a third connection point between the fifth switch element and the sixth switch element and to a fourth connection point between the seventh switch element and the eighth switch element; and
the control section controls the fifth switch element, the sixth switch element, the seventh switch element, and the eighth switch element.
